(19) United States
(12) Patent Application Publication
(10) Pub. No.: US 2026/0291069 A1
(43) Pub. Date: Sep. 24, 2026

(54) ANTENNA DEVICE AND ELECTRONIC DEVICE INCLUDING THE SAME

(71) Applicant: DONGWOO FINE-CHEM CO., LTD., Jeonbuk-do (KR)

(72) Inventors: YOON HO HUH, Jeonbuk-do (KR); DO HYOUNG KWON, Jeonbuk-do (KR); WON HEE LEE, Jeonbuk-do (KR); JONG SU LEE, Jeonbuk-do (KR); SUNG JOON HONG, Jeonbuk-do (KR)

(21) Appl. No.: 19/569,756

(22) Filed: Mar. 17, 2026

(30) Foreign Application Priority Data
Mar. 18, 2025 (KR) 10-2025-0034557

(51) Int. Cl. H01Q 9/04; H01Q 1/27

(52) U.S. Cl. CPC H01Q 9/0414; H01Q 1/273

(57) ABSTRACT

An antenna device includes an antenna dielectric layer having a curved circumference and a radiator extending along the curved circumference of the antenna dielectric layer and having a curved shape. A length ratio of the radiator relative to the curved circumference of the antenna dielectric layer is in a range from 0.1 to 0.3.

### CROSS-REFERENCE TO RELATED APPLICATION AND CLAIM OF PRIORITY

This application claims priority to Korean Patent Application No. 10-2025-0034557 filed on Mar. 18, 2025 in the Korean Intellectual Property Office (KIPO), the entire disclosures of which are incorporated by reference herein.

### BACKGROUND

### 1. Field

The present invention relates to an antenna device and an electronic device including the same. More particularly, the present invention relates to an antenna device including a radiator and a dielectric layer, and an electronic device including the same.

### 2. Description of the Related Art

With recent developments of information society, wireless communication technologies such as Wi-Fi and Bluetooth are applied or embedded in image display devices, electronic devices and buildings. With a recent evolution of mobile communication technology, an antenna for performing, e.g., high-frequency or ultra-high frequency band communication is being applied to public transportation such as a bus and a subway, a building structures, various mobile devices, wearable devices, and the like.

For example, when the antenna is applied to an electronic device such as an image display device, mutual interference may occur between a conductor such as an electrode and a wiring included in the electronic device, and the antenna.

Further, if the antenna covers a display area of the image display device or the antenna is visually recognized by the user, image properties of the image display device may be deteriorated.

Thus, an antenna design that can suppress disturbance from electrical/optical properties in the image display device while maintaining or enhancing the antenna radiation properties may be needed.

### SUMMARY

According to an aspect of the present invention, there is provided an antenna device having improved radiation properties and electrical properties.

According to an aspect of the present invention, there is provided an electronic device including an antenna device having improved radiation properties and electrical properties.
(1) An antenna device, including: an antenna dielectric layer having a curved circumference; and a radiator extending along the curved circumference of the antenna dielectric layer and having a curved shape, wherein a length ratio of the radiator relative to the curved circumference of the antenna dielectric layer is in a range from 0.1 to 0.3.
(2) The antenna device of the above (1), wherein the antenna dielectric layer has a circular shape, and the radiator has an arc shape of a circular sector,
(3) The antenna device of the above (1), wherein the length ratio is in a range from 0.11 to 0.29.
(4) The antenna device of the above (1), wherein a separation distance between the radiator and the curved circumference of the antenna dielectric layer is in a range from 30 μm to 500 μm.
(5) The antenna device of the above (4), wherein the separation distance is in a range from 50 μm to 400 μm.
(6) The antenna device of the above (1), further including a pad portion connected to one end portion of the radiator, wherein a lateral side of the one end portion of the radiator and one lateral side of the pad portion are integrally connected to form the same straight line.
(7) The antenna device of the above (6), wherein the straight line passes through a center of the antenna dielectric layer.
(8) The antenna device of the above (6), wherein the radiator is bent from the pad portion to extend clockwise or counterclockwise
(9) The antenna device of the above (6), further including a circuit board that includes: a core layer; and a signal wiring disposed on one surface of the core layer and electrically connected to the radiator through the pad portion.
(10) The antenna device of the above (9), wherein the circuit board further includes a co-planar ground disposed at the same level as that of the signal wiring on the one surface of the core layer and spaced apart from the signal wiring.
(11) The antenna device of the above (9), wherein the circuit board further includes a vertical ground disposed on the other surface of the core layer opposite the one surface to overlap the signal wiring.
(12) The antenna device of the above (1), wherein a width of the radiator is in a range from 200 μm to 2,000 μm.
(13) The antenna device of the above (12), wherein the width of the radiator is in a range from 300 μm to 1,500 μm.
(14) An electronic device, including: a display panel; and the above-described antenna device disposed on the display panel.
(15) The electronic device of the above (14), wherein the electronic device includes a smartwatch.
(16) The electronic device of the above (15), wherein the electronic device has a display area and a peripheral area, and the radiator of the antenna device is disposed within or adjacent to the peripheral area and extends along the peripheral area.
(17) The electronic device of the above (14), further including a rear board disposed under the display panel, the rear board having a second connection structure mounted thereon, wherein the antenna device further includes a circuit board connected to the radiator, and the circuit board has a first connection structure mounted thereon, wherein the circuit board is bent toward the rear board such that the first connection structure and the second connection structure are coupled to each other.
(18) The electronic device of the above (17), wherein the first connection structure is a first connector or a pogo pin, and the second connection structure is a second connector coupled with the first connector or a pin pad connected to the pogo pin.

An antenna device according to embodiments may include a curved radiator extending along a curved circumference on a top surface of a dielectric layer having the curved circumference. Accordingly, antenna radiation properties may be achieved while avoiding an interference with electrical/optical properties of an electronic device to which the antenna device is applied.

In example embodiments, gain properties of the antenna device may be improved by adjusting a ratio of a length of the curved radiator to a length of the circumference of the dielectric layer.

In some embodiments, the gain properties of the antenna device may be improved by adjusting a separation distance of the curved radiator from the circumference of the dielectric layer.

The antenna device may be applied to an electronic device having a curved circumference such as an image display device and a wearable device such as a smart watch, so that the electronic device providing high-frequency or ultra-high-frequency communication can be effectively implemented.

### BRIEF DESCRIPTION OF THE DRAWINGS

FIG. 1 is a schematic plan view illustrating an antenna device according to embodiments.

FIG. 2 is a schematic partially enlarged plan view illustrating an antenna device according to embodiments.

FIG. 3 is a schematic plan view illustrating an antenna device according to embodiments.

FIG. 4 is a schematic cross-sectional view illustrating an antenna device according to embodiments.

FIG. 5 is a schematic perspective view illustrating an electronic device according to embodiments.

FIG. 6 is a schematic cross-sectional view illustrating an electronic device according to embodiments.

FIG. 7 is a graph illustrating a gain according to a frequency of antenna devices of Examples and Comparative Examples.

FIG. 8 is a graph illustrating a gain according to a frequency of antenna devices of Example.

### DETAILED DESCRIPTION OF THE EMBODIMENTS

Embodiments of the present invention provide an antenna device including a dielectric layer and a radiator having a curved shape. Embodiments of the present invention provide an electronic device including the antenna device.

Hereinafter, the present invention will be described in detail with reference to the accompanying drawings. However, those skilled in the art will appreciate that such embodiments described with reference to the accompanying drawings are provided to in further understand the spirit of the present invention and do not limit subject matters to be protected as disclosed in the detailed description and appended claims.

The terms “first,” “second,” “third,” “one end,” “the other end,” “upper side,” “lower side,” “lateral side”, etc., herein are used to relatively distinguish positions of components, and are not intended to designate absolute positions.

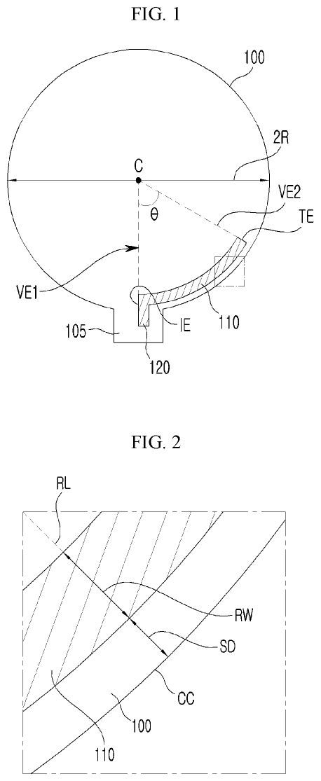

FIG. 1 is a schematic plan view illustrating an antenna device according to embodiments.

Referring to FIG. 1, an antenna device may include an antenna dielectric layer 100 and a radiator 110 disposed on the antenna dielectric layer 100 and having a curved shape.

In some embodiments, the antenna dielectric layer 100 may include a transparent resin material. For example, the antenna dielectric layer 100 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more therefrom.

In an embodiment, the antenna dielectric layer 100 may include a cyclic olefin polymer (COP)-based material.

In some embodiments, an adhesive film such as an optically clear adhesive (OCA) or an optically clear resin (OCR) may be included in the antenna dielectric layer 100.

In some embodiments, the antenna dielectric layer 100 may include an inorganic insulating material such as silicon oxide, silicon nitride, silicon oxynitride, glass, etc.

In an embodiment, the antenna dielectric layer 100 may be provided as a substantially single layer.

In an embodiment, the antenna dielectric layer 100 may include a multi-layered structure of at least two or more layers. For example, the antenna dielectric layer 100 may include a substrate layer and an antenna dielectric layer, and may include an adhesive layer between the substrate layer and the antenna dielectric layer.

An impedance or an inductance of the antenna unit may be formed by the antenna dielectric layer 100 so that a frequency band in which the antenna structure may be driven or operated may be adjusted. In some embodiments, a dielectric constant of the antenna dielectric layer 100 may be adjusted in a range from about 1.5 to about 12. When the dielectric constant is greater than about 12, a driving frequency may be excessively reduced and driving in a high frequency band may not be implemented.

In some embodiments, a connection support layer 105 may be connected to the antenna dielectric layer 100. The connection support layer 105 may be provided as a dielectric layer supporting electrical bonding or adhesion of a circuit board 150 and a pad portion 120 as will be described later.

The connection support layer 105 may have a bar shape protruding from the antenna dielectric layer 100. The connection support layer 105 may include substantially the same material as that of the antenna dielectric layer 100, and may be formed of a single member substantially integral with the antenna dielectric layer 100.

According to embodiments of the present invention, the antenna dielectric layer 100 may have a curved circumference. In some embodiments, the antenna dielectric layer 100 may have a substantially circular or elliptical shape.

The radiator 110 may have a curved shape extending along the curved circumference of the antenna dielectric layer 100. In example embodiments, the radiator 110 may extend in the curved shape along the curved circumference of the antenna dielectric layer 100 from a specific point of the circumference of the antenna dielectric layer 100.

In example embodiments, the curved circumferences of the radiator 110 and the antenna dielectric layer 100 may have substantially the same curvature.

The radiator 110 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy containing at least one thereof. These may be used alone or in a combination of two or more therefrom.

In an embodiment, the radiator 110 may include silver (Ag) or a silver alloy (e.g., a silver-palladium-copper (APC) alloy), or copper (Cu) or a copper alloy (e.g., a copper-calcium (CuCa) alloy) for low resistance implementation and fine line width patterning.

In some embodiments, the radiator 110 may substantially consist of the above-described metal or alloy.

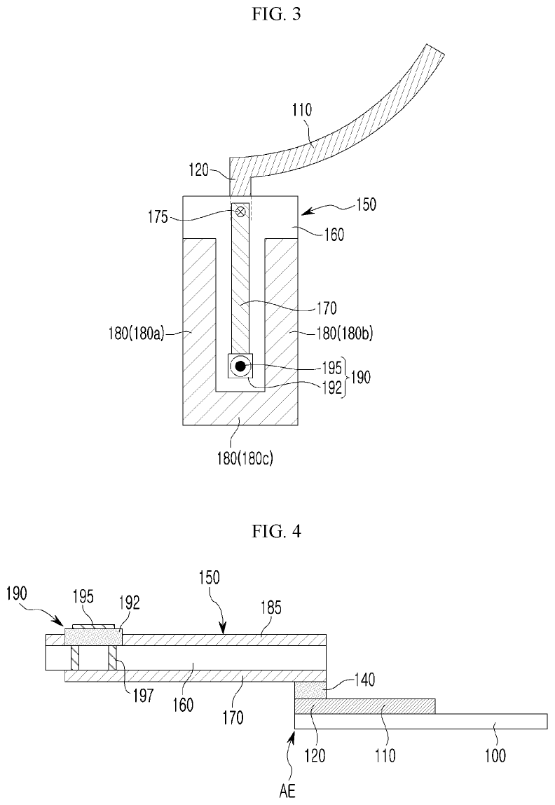

The antenna device may further include the pad portion 120 connected to the radiator 110. The pad portion 120 may be disposed on the connection support layer 105 to be electrically connected to a signal wiring 170 (see FIG. 3) included in the circuit board 150.

The radiator 110 may have a shape bent from the pad portion 120, and may extend clockwise or counterclockwise from the pad portion 120. The pad portion 120 may include substantially the same material as that of the radiator 110, and may be formed as a single member substantially integral with the radiator 110.

In example embodiments, one lateral side of the pad portion 120 and one lateral side of the radiator 110 may substantially coincide with each other. For example, one lateral side of the pad portion 120 and one lateral side of one end portion IE of the radiator 110 may be integrally connected to form the same straight line.

One end portion IE of the radiator 110 may be an initiating end portion extending from the pad portion 120.

In some embodiments, a first virtual straight line VE1 extending from one lateral side of the pad portion 120 and one lateral side of one end portion IE of the radiator 110 may pass through a center C of a top surface of the antenna dielectric layer 100. The center C may be a center of a circle or a center of an ellipse. In an embodiment, the center C may be the center of the circle.

In some embodiments, a second virtual straight line VE2 extending from a lateral side of the other end portion TE of the radiator 110 may pass through the center C of the top surface of the antenna dielectric layer 100.

The first virtual straight line VE1 and the second virtual straight line VE2 may form an intersection angle θ at the center C of the top surface of the antenna dielectric layer 100.

According to embodiments of the present invention, a ratio of a length of the radiator 110 to the curved circumference of the dielectric layer may be in a range from 0.1 to 0.3. When the ratio of the length is less than 0.1, sufficient radiation properties and an antenna gain may not be achieved from the radiator 110. For example, a sufficient gain may not be achieved in a band in a range of 0.5 GHz to 5 GHz.

When the ratio of length is greater than 0.3, an offset of a radiation waveform may occur as an extending length of the radiator 110 increases along the curved circumference. Accordingly, the radiation properties and gain in a high frequency band may be deteriorated.

In some embodiments, the ratio of length may be in a range from 0.11 to 0.29, or from 0.12 to 0.28. In an embodiment, the ratio of length may be in a range from 0.12 to 0.26, from 0.15 to 0.26, or from 0.20 to 0.26.

In some embodiments, a length of the curved circumference of the antenna dielectric layer 100 may be calculated as 2πR. As indicated in FIG. 1, R may correspond to a radius of the curved circumference, and 2R may correspond to a diameter of the curved circumference.

In some embodiments, the radiator 110 has a shape of an arc of a circular sector, and the length of the radiator 110 may correspond to a length of the arc. For example, the length of the radiator 110 may be calculated by Equation 1 below.

length of radiator=(R−SD)*θ [Equation 1]

In Equation 1, R represents a radius of the curved circumference of the antenna dielectric layer 100. SD represents a separation distance of the radiator 110 from the curved circumference of the antenna dielectric layer 100. θ represents an intersection angle between the first virtual straight line VE1 and the second virtual straight line VE2.

FIG. 2 is a partially enlarged plan view schematically illustrating an antenna device according to embodiments. For example, FIG. 2 is a partially enlarged plan view of an area indicated by a dotted square of FIG. 1.

Referring to FIG. 2, the radiator 110 may have a separation distance SD from the curved circumference CC of the antenna dielectric layer 100. The separation distance SD may be a radial distance between an outer circumference of the radiator 110 and the curved circumference CC of the antenna dielectric layer 100.

For example, in FIG. 2, lines by which a width RW of the radiator 110 and the separation distance SD of the radiator 110 are measured may form a straight line, and the straight line may extend to coincide with a radial direction straight line RL.

In example embodiments, the separation distance SD of the radiator 110 may be in a range from 30 μm to 500 μm. In the above range, electrical interference between the radiator 110 and an external frame of the electronic device, and electrical interference with a sensor electrode, a transistor electrode/wiring included in a display panel, etc., may be prevented. Accordingly, independent radiation properties of the radiator 110 may be easily achieved.

In some embodiments, the separation distance SD of the radiator 110 may be in a range from 50 μm to 400 μm, from 50 μm to 300 μm, from 50 μm to 200 μm, or from 50 μm to 150 μm. In the above range, radiation independence of the radiator 110 may be more easily obtained from elements of the electronic device.

In some embodiments, the width RW of the radiator 110 may be greater than the separation distance SD. Accordingly, sufficient radiation properties and an antenna gain may be achieved through an outer periphery of the electronic device or the antenna dielectric layer 100.

In an embodiment, the width RW of the radiator 110 may be in a range from 200 μm to 2,000 μm, from 300 μm to 1,500 μm, from 300 μm to 1,400 μm, or from 400 μm to 1,200 μm.

In example embodiments, a resonance frequency band of the antenna device AE described above may cover LTE and WIFI bands. In some embodiments, the resonance frequency band of the antenna device AE may be in a range from 0.1 GHz to 5 GHZ, or from 0.5 GHz to 4 GHz.

FIG. 3 is a schematic plan view illustrating an antenna device according to embodiments. FIG. 4 is a schematic cross-sectional view illustrating an antenna device according to embodiments. For convenience of illustration and description, illustration of the antenna dielectric layer 100 is omitted of FIG. 3.

Referring to FIGS. 3 and 4, the antenna device may further include a circuit board 150 electrically connected to the radiator 110. The antenna device AE including the above-described antenna dielectric layer 100 and the radiator 110 (including the pad portion 120) is provided, and the circuit board 150 may be coupled to the antenna device AE. Accordingly, the antenna device in the form of a module or a package may be provided.

The circuit board 150 may include a core layer 160 and a signal wiring 170 formed on one surface of the core layer 160. The core layer 160 may include a flexible resin such as a polyimide resin, a modified polyimide (MPI), an epoxy resin, a polyester, a cyclo olefin polymer (COP), a liquid crystal polymer (LCP), or the like. In a preferable embodiment, the core layer 160 may include the polyimide resin or the MPI.

In example embodiments, the circuit board 150 may be a flexible printed circuit board (FPCB) including the above-described flexible resin.

One end portion of the signal wiring 170 may be electrically connected to the pad portion 120. Accordingly, feeding and signal transfer may be performed to the radiator 110 through the signal wiring 170.

The other end portion of the signal wiring 170 may be connected to a first connection structure 190. The first connection structure 190 may be mounted on a surface of the core layer 160 by, e.g., a surface mounting technology (SMT).

The first connection structure 190 may include an insulator 192 and an external connection conductor 195 coupled to the insulator 192.

The one end portion of the signal wiring 170 may be electrically connected to the pad portion 120 of the antenna device AE through a conductive intermediate structure such as a contact 175 or an anisotropic conductive film 140.

In an embodiment, as illustrated in FIG. 3, the one end portion of the signal wiring 170 may be electrically connected to the pad portion 120 of the antenna device AE through the contact 175 penetrating the core layer 160. In this case, the signal wiring 170 and the first connection structure 190 may be disposed together on an outer surface of the core layer 160.

In an embodiment, as illustrated in FIG. 4, the one end portion of the signal wiring 170 may be electrically connected to the pad portion 120 of the antenna device AE through the anisotropic conductive film 140.

For example, the one end portion and the pad portion 120 of the signal wiring 170 may be heated and compressed with the anisotropic conductive film 140 interposed therebetween. Accordingly, an electrical connection between the signal wiring 170 and the pad portion 120 may be implemented.

In this case, the signal wiring 170 may be disposed on an inner surface of the core layer 160, and the first connection structure 190 may be disposed on the outer surface of the core layer 160. The first connection structure 190 may include a signal pin 197 penetrating the core layer 160. The first connection structure 190 may be in contact with or electrically connected to the signal wiring 170 through the signal pin 197. The signal pin 197 may be connected to the external connection conductor 195 within the insulator 192.

The inner surface of the core layer 160 may refer to a surface adjacent to the antenna device AE of the circuit board 150 or the core layer 160. The outer surface of the core layer 160 may refer to a surface facing the inner surface. Based on the cross-section of FIG. 4, the outer surface and the inner surface of the core layer 160 may correspond to upper and lower surfaces of the core layer 160, respectively.

In some embodiments, the circuit board 150 may further include a co-planar ground 180. The co-planar ground 180 may include a portion disposed at the same level or on the same plane as that of the signal wiring 170 and extending to be substantially parallel to the signal wiring 170.

As illustrated in FIG. 3, the co-planar ground 180 may include a first portion 180a and a second portion 180b facing each other with the signal wiring 170 interposed therebetween. The first portion 180a and the second portion 180b may be physically separated from the signal wiring 170 and may be substantially parallel to the signal wiring 170.

In some embodiments, the co-planar ground 180 may further include a connection portion 180c connecting end portions of the first portion 180a and the second portion 180b.

In some embodiments, the circuit board 150 may further include a vertical ground 185 facing the signal wiring 170 with the core layer 160 interposed therebetween. When the signal wiring 170 is disposed on the outer surface of the core layer 160, the vertical ground 185 may be disposed on the inner surface of the core layer 160. When the signal wiring 170 is disposed on the inner surface of the core layer 160, the vertical ground 185 may be disposed on the outer surface of the core layer 160.

Noises around the signal wiring 170 may be blocked by the co-planar ground 180, and an electric field concentration to the antenna device AE may be promoted. Noises directed to the circuit board 150 from an electronic device or an external environment may be additionally blocked by the vertical ground 185, and the electric field concentration may be further increased.

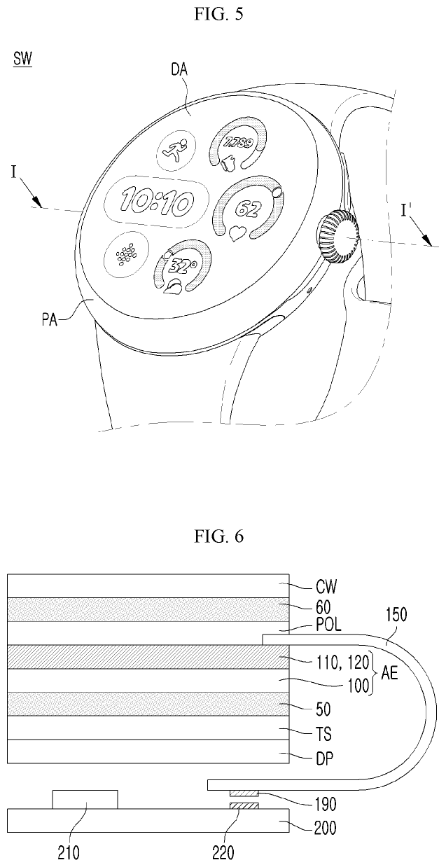

FIG. 5 is a schematic perspective view illustrating an electronic device according to embodiments. FIG. 6 is a schematic cross-sectional view illustrating an electronic device according to embodiments. For example, FIG. 6 is a cross-sectional view taken along a line I-I′ of FIG. 5 in a thickness direction.

In example embodiments, the electronic device may include a display device. In some embodiments, the electronic device may include a wearable device including a display device. In an embodiment, the electronic device may include a smart watch SW, as illustrated in FIG. 5.

Referring to FIG. 5, e.g., an electronic device implemented in the form of the smart watch SW may include a circular body, and the circular body may include a display area DA and a peripheral area PA. The peripheral area PA may be substantially a bezel area of the circular body.

The radiator 110 of the antenna device AE may extend along the peripheral area PA. In an embodiment, the radiator 110 may be disposed within the peripheral area PA. In an embodiment, the radiator 110 may be disposed over a boundary between the peripheral area PA and the display area DA. In an embodiment, the radiator 110 may be disposed on an outer portion of the display area DA adjacent to the peripheral area PA.

Referring to FIG. 6, the electronic device may include a display panel DP and the antenna device stacked on the display panel DP. The electronic device may further include a cover window CW disposed on the antenna device to provide a display screen or an outermost surface of FIG. 5.

The display panel DP may include, e.g., a thin film transistor (TFT) array substrate. The display panel DP may be disposed on the TFT array substrate, and may include a display element including a stack of an anode-a display layer-a cathode. For example, the display layer may include an organic emission layer, and the display element may be an organic light-emitting diode (OLED) element.

The antenna device AE may be disposed on the display panel DP. In some embodiments, a touch sensor layer TS may be disposed between the antenna device AE and the display panel DP.

In an embodiment, the touch sensor layer TS may include a sensor substrate layer and sensing electrodes arranged on the sensor substrate layer. In an embodiment, the touch sensor layer TS may be included as an on-cell type sensor including sensing electrodes directly formed on the display panel DP.

A first adhesive layer 50 may be formed between the antenna device AE and the display panel DP. For example, the first adhesive layer 50 may be formed between the antenna device AE and the touch sensor layer TS.

In some embodiments, a polarizing layer POL may be stacked on the antenna device AE. The polarizing layer POL may include a coated polarizer or a polarizing plate. The coated polarizer may include a liquid crystal coating layer including a polymerizable liquid crystal compound and a dichroic dye. In this case, the polarizing layer POL may further include an alignment layer for generating an orientation to the liquid crystal coating layer.

For example, the polarizing plate may include a polyvinyl alcohol-based polarizer and a protective film attached to at least one surface of the polyvinyl alcohol-based polarizer.

The cover window CW may include, e.g., glass or a transparent resin film. In some embodiments, a light-shielding pattern may be formed on a peripheral portion of one surface of the cover window CW. The light-shielding pattern may include, e.g., a color printing pattern, and may have a single-layered structure or a multi-layered structure. The peripheral area PA or the bezel area may be defined by the light-shielding blocking pattern.

For example, a second adhesive layer 60 may be formed between the polarizing layer POL and the cover window CW. In some embodiments, an adhesive layer may be formed between the antenna device AE and the polarizing layer POL.

The electronic device may further include a rear board 200 disposed under the display panel DP. In example embodiments, the rear board 200 may be a main board in the form of a rigid circuit board. A circuit element 210 and a second connection structure 220 may be mounted on the rear board 200.

For example, the circuit element 210 may include a display driving integrated circuit chip for driving the TFT array substrate, a touch sensor driving integrated circuit chip, an antenna driving integrated circuit chip, an AP (application) processor, or the like. The second connection structure 220 may be electrically connected to the antenna driving integrated circuit chip through a wiring included in the rear board 200.

One end portion of the circuit board 150 may be coupled to the pad portion 120 of the antenna device AE. The circuit board 150 may be bent downward with respect to the antenna device AE so that the first connection structure 190 mounted on the other end portion of the circuit board 150 and the second connection structure 220 mounted on the rear board 200 may be coupled to each other.

Accordingly, an electrical connection structure between the antenna driving integrated circuit chip—the circuit board 150—the antenna device AE may be implemented.

Each of the first connection structure 190 and the second connection structure 220 may include a connector, a pogo pin, a c-clip, or the like.

In an embodiment, the first connection structure 190 may be a first connector, and the second connection structure 220 may be a second connector coupled to the first connector.

In an embodiment, the first connection structure 190 may be a pogo pin, and the second connection structure 220 may be a pin pad in contact with or connected to the pogo pin.

As described above, the length ratio and the separation distance of the radiator 110 may be adjusted, so that desired radiation properties may be implemented while suppressing electrical interference with the display panel DP and/or the touch sensor layer TS. Additionally, deterioration of image quality implemented from the display panel DP by the radiator 110 may be prevented.

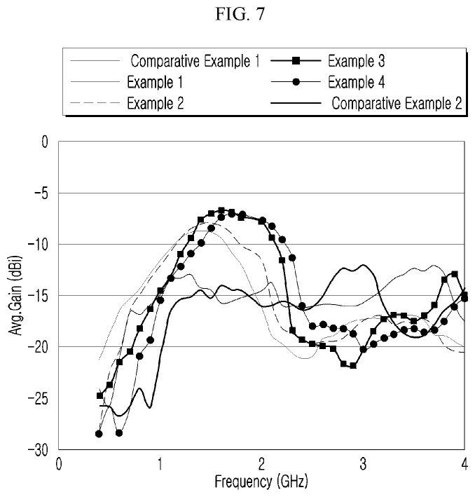

FIG. 7 is a graph illustrating a gain according to a frequency of antenna devices of Examples and Comparative Examples.

Specifically, a circular COP antenna dielectric layer 100 having a diameter (a length of a curved circumference of about 103 mm) of 32.8 mm was prepared. The separation distance SD of the radiator 110 from the curved circumference CC of the antenna dielectric layer 100 was fixed to 200 μm, and the width RW of the radiator 110 was fixed to 500 μm.

As shown in Table 1, an average gain was measured within the radiation chamber while adjusting a length ratio of the radiator 110 to the curved circumference (CC).

TABLE 1

| | length of | length | average gain |
|---|---|---|---|
| | radiator (mm) | ratio | (Avg. Gain) |
| Example 1 | 27 | 0.26 | −8.7 dBi |
| Example 2 | 22 | 0.21 | −7.9 dBi |
| Example 3 | 17 | 0.17 | −6.7 dBi |
| Example 4 | 12 | 0.12 | −7.0 dBi |
| Comparative | 32 | 0.31 | −15.8 dBi |
| Example 1 | | | |
| Comparative | 7 | 0.07 | −15.7 dBi |
| Example 2 | | | |

Referring to FIG. 7 and Table 1, a significantly increased antenna gain was achieved from Examples in which the length ratio of the radiator was adjusted in the range of 0.1 to 0.3 compared to those from Comparative Examples.

Specifically, in Comparative Example 1 where the length ratio exceeded 0.3, an electric field was canceled due to the increase in the length of the radiator 110 and the antenna gain was significantly reduced. In Comparative Example 2 where the length ratio was less than 0.1, the antenna gain was significantly reduced due to the insufficient radiator area.

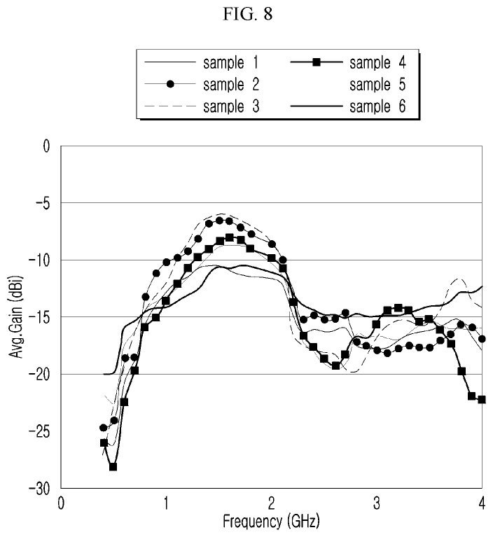

FIG. 8 is a graph illustrating a gain according to a frequency of antenna devices of Example.

Specifically, a circular COP antenna dielectric layer 100 having a diameter (a length of a curved circumference of about 103 mm) of 32.8 mm was prepared. The length of the radiator 110 was fixed to 17.08 mm, and the width RW of the radiator 110 was fixed to 500 μm.

A plurality of smart watch samples were manufactured by adjusting the separation distance SD of the radiator 110 from the curved circumference CC of the antenna dielectric layer 100 as shown in Table 2. Thereafter, an average gain of each sample was measured in the radiation chamber.

TABLE 2

| | separation | average gain |
|---|---|---|
| | distance (μm) | (Avg. Gain) |
| Sample 1 | 25 | −10.5 dBi |
| Sample 2 | 50 | −6.6 dBi |
| Sample 3 | 100 | −6.2 dBi |
| Sample 4 | 200 | −8.0 dBi |
| Sample 5 | 400 | −8.9 dBi |
| Sample 6 | 600 | −10.7 dBi |

Referring to Table 2, an antenna gain greater than −10 dBi was achieved in Samples 2 to 5 where the separation distance was adjusted in the range of 30 μm to 500 μm, e.g., of 50 μm to 400 μm.

In Sample 1 having the separation distance of less than 30 μm, the antenna gain was reduced due to an electric field interference with an external frame of a smart watch. In Sample 6 having the separation distance exceeding 500 μm, the antenna gain was reduced due to an electric field interference with a TFT electrode and a touch sensing electrode.

What is claimed is:

1. An antenna device, comprising:
an antenna dielectric layer having a curved circumference; and
a radiator extending along the curved circumference of the antenna dielectric layer and having a curved shape,
wherein a length ratio of the radiator relative to the curved circumference of the antenna dielectric layer is in a range from 0.1 to 0.3.

2. The antenna device of claim 1, wherein the antenna dielectric layer has a circular shape, and the radiator has an arc shape of a circular sector.

3. The antenna device of claim 1, wherein the length ratio is in a range from 0.11 to 0.29.

4. The antenna device of claim 1, wherein a separation distance between the radiator and the curved circumference of the antenna dielectric layer is in a range from 30 μm to 500 μm.

5. The antenna device of claim 4, wherein the separation distance is in a range from 50 μm to 400 μm.

6. The antenna device of claim 1, further comprising a pad portion connected to one end portion of the radiator,
wherein a lateral side of the one end portion of the radiator and one lateral side of the pad portion are integrally connected to form the same straight line.

7. The antenna device of claim 6, wherein the straight line passes through a center of the antenna dielectric layer.

8. The antenna device of claim 6, wherein the radiator is bent from the pad portion to extend clockwise or counterclockwise.

9. The antenna device of claim 6, further comprising a circuit board that comprises:
a core layer; and
a signal wiring disposed on one surface of the core layer and electrically connected to the radiator through the pad portion.

10. The antenna device of claim 9, wherein the circuit board further comprises a co-planar ground disposed at the same level as that of the signal wiring on the one surface of the core layer and spaced apart from the signal wiring.

11. The antenna device of claim 9, wherein the circuit board further comprises a vertical ground disposed on the other surface of the core layer opposite the one surface to overlap the signal wiring.

12. The antenna device of claim 1, wherein a width of the radiator is in a range from 200 μm to 2,000 μm.

13. The antenna device of claim 12, wherein the width of the radiator is in a range from 300 μm to 1,500 μm.

14. An electronic device comprising:
a display panel; and
the antenna device of claim 1 disposed on the display panel.

15. The electronic device of claim 14, wherein the electronic device includes a smartwatch.

16. The electronic device of claim 15, wherein the electronic device has a display area and a peripheral area, and the radiator of the antenna device is disposed within or adjacent to the peripheral area and extends along the peripheral area.

17. The electronic device of claim 14, further comprising a rear board disposed under the display panel, the rear board having a second connection structure mounted thereon,
wherein the antenna device further comprises a circuit board connected to the radiator, and the circuit board has a first connection structure mounted thereon,
wherein the circuit board is bent toward the rear board such that the first connection structure and the second connection structure are coupled to each other.

18. The electronic device of claim 17, wherein the first connection structure is a first connector or a pogo pin, and the second connection structure is a second connector coupled with the first connector or a pin pad connected to the pogo pin.
